(19) United States
(12) Patent Application Publication
(10) Pub. No.: US 2019/0218969 A1
(43) Pub. Date: Jul. 18, 2019

(54) AIRCRAFT TURBINE ENGINE WITH EPICYCLIC REDUCTION GEAR HAVING A VARIABLE REDUCTION RATIO

(71) Applicant: SAFRAN HELICOPTER ENGINES, Bordes (FR)

(72) Inventors: Benjamin Fulleringer, Moissy-Cramayel (FR); Yannick Cazaux, Moissy-Cramayel (FR); Damien Lecouvreur, Moissy-Cramayel (FR)

(73) Assignee: SAFRAN HELICOPTER ENGINES, Bordes (FR)

(21) Appl. No.: 16/300,023

(22) PCT Filed: May 23, 2017
(86) PCT No.: PCT/FR2017/051266

§ 371 Date: Apr. 3, 2019

(30) Foreign Application Priority Data
May 24, 2016 (FR) 1654644

(51) Int. Cl. F02C 3/113; F02C 7/32; F02C 7/36; F16H 3/72

(52) U.S. Cl. CPC F02C 3/113; F02C 7/32; F02C 7/36; F05D 2260/90; F05D 2220/329; F05D 2220/50; F05D 2260/40311; F16H 3/728

(57) ABSTRACT

An aircraft turbine engine includes a rotating body comprising a compressor rotor and a turbine rotor interconnected by a rotor shaft, the turbine engine being configured to drive a member by said rotor shaft via an epicyclic reduction gear, said epicyclic reduction gear comprising a first element (50) configured to be rotationally secured to said shaft, a second element (56) rotationally secured to said member, and a third element configured to be selectively secured to a stator of the turbine engine and disengaged from the stator, wherein the turbine engine comprises driving means to rotationally drive said third element at a piloted speed when it is disengaged from said stator.

### TECHNICAL FIELD

The present invention relates to an aircraft turbine engine with epicyclic reduction gear allowing the realisation of a continuously variable reduction ratio.

### STATE OF THE ART

A turbine engine comprises a gas generator comprising at least one compressor stage, a combustion chamber and at least one turbine stage. The air is sent under pressure into the combustion chamber thanks to the compressor(s). The air is mixed with a fuel, ignited and used to drive the turbine(s). Power is retrieved from the turbine(s) to mechanically drive back the compressor(s).

Depending on the intended application, a turbine engine can be used, for example, to:
propel an aircraft by using the hot gases exiting the turbine (turbojet), or
propel an aircraft by retrieving the mechanical power to drive a turbofan or a propeller (turboprop) or a rotor (turbine engine or APU, which stands for Auxiliary Power Unit). There are usually two ways to retrieve the power:
   retrieval directly from the body of the gas generator (in the case where the gas generator is of the linked turbine type).
   retrieval from one stage of the turbine (gas generator is of the free turbine type).

The unit formed by a compressor rotor, a turbine rotor and a shaft connecting these rotors is called a (rotating) body.

In certain applications, such as for helicopters, the turbine engines can feature a monoblock body (FIGS. 1 and 2). The monoblock body can be associated with a linked turbine (FIG. 1) or with a free turbine (FIG. 2), i.e. the turbine is either connected or not from the of the gas generator.

When the required power becomes too high, the gas generator requires a second body and, in some cases, a third body.

In the abovementioned application relating to helicopter turbine engines with a linked turbine, the mechanical power is retrieved directly from the gas generator. As the rotor of the helicopter has to rotate at a near-constant speed during all flight phases, the gas generator is running at a constant speed. Thus, the following advantages and disadvantages can be observed:
the functioning of the gas generator is limited to a constant speed in a linked turbine, said speed being set by the target speed of the rotor and the constant reduction ratio of the transmission chain,
the responsiveness of the engine to transients is good, since the gas generator is already rotating at the desired (high) speed, the compression rate of the compressor being immediately available,
at full power, the engine is closer to the pumping line, while providing a good compressor yield.
at low power, the gas generator rotates quickly, resulting in poor yield on partial loads.
a simplified engine architecture,
a need to use a clutch to avoid driving the rotor when starting the engine,
an electronic overspeed protection is sufficient, considering the inertia of the gas generator (lack of shielding).

In free turbine architectures, the rotation speed of the gas generator is variable and independent of the rotation speed of the rotor. The free turbine is driven by the gases exiting the turbine. The speed of the gas generator increases according to the power to be supplied to the free turbine. In this solution, the compressor is, among other things, optimised to work in parallel with the pumping line, thereby ensuring a satisfactory compressor yield. Thus, the following advantages and disadvantages can be observed:
the functioning of the gas generator is limited to an operating line in free turbine mode, the speed of the free turbine being set by the target speed of the rotor and the constant reduction ratio of the transmission chain,
a satisfactory engine yield throughout the entire flight range,
an almost permanent pumping margin making piloting easier,
a complex engine architecture (free turbine and its bearings on a shock absorber with oil film compression, transversal supercritical shafts affecting the diameter of the discs),
a complex overspeed protection system (shielding), and
limited responsiveness as the speed amplitude of the gas generator is high.

It is also known to drive the fan of a turbine engine via an epicyclic reduction gear connected to the low pressure body, as described in document FR-A1-2 817 912.

Thus, on the one hand, the LP turbine can rotate faster, thereby reducing the number of necessary stages, and on the other hand, the diameter of the fan can be increased as it rotates slowly. This solution simplifies the architecture of the gas generator but adds a component: the reduction gear. The reduction gear ratio is constant and enables to optimise the fan and the HP turbine differently, as they are able to rotate at different speeds. This optimisation can be achieved on a specific operating point, but cannot be adapted to the different flight phases of the aircraft.

The choice of the reduction ratio of the abovementioned epicyclic gear train enables optimisation, but does not allow the gas generator to adapt freely to the varying demand.

To overcome this problem, document U.S. Pat. No. 8,181,442 proposes a toroidal continuously variable transmission (CVT), which enables to select, through the angular position of the planet, the reduction ratio of the toroidal CVT. This technology has thus made it possible to simplify the gas generator by adopting a “linked turbine” architecture type. This toroidal transmission has the disadvantage of relying only on friction to transmit the motion. Low torques can therefore be transmitted, or very high preloads are required.

For a helicopter application, this solution has the following advantages:
allow a simplification of the engine architecture (gain in cost and weight) if it is associated with a linked turbine, by eliminating the transversal supercritical shaft, reducing the diameter of the discs, and eliminating the shielding of the free turbine, and
enabling exploration of the entire domain in the compressor field and a strategy to optimise the performance of the engine.

However, it has the following disadvantages: it does not enable to disengage the rotor, requiring the use of a clutch, and it does not allow to transmit high torques, imposing an additional transmission downstream from the toroidal CVT.

Finally, document FR-A1-2 405 367 also discloses a turbine engine whose reduction gear has its ring gear configured to be selectively secured to a stator of the turbine engine and disconnected from said stator.

One embodiment of document WO-2015/006153-A2 and document US-2014/290265-A1 each describe and demonstrate a turbine engine whose reduction gear has a ring gear which is configured to be rotated to vary the reduction ratio. However, the driving means cannot be reliably blocked as they cannot be secured to the stator of the turbine engine.

Other embodiments in document WO-2015/006153-A2 describe and represent a turbine engine whose reduction gear has its planetary carrier configured to be rotationally driven to change the reduction ratio of the reduction gear, and that can be selectively secured to the casing of the turbine engine. However, the choice of the coupling between the planetary carrier of the reduction gear and the driving means does not provide for a suitable range of reduction ratios.

The present invention provides an improvement to the current technologies described above.

### PRESENTATION OF THE INVENTION

For this purpose, the invention discloses an aircraft turbine engine, comprising at least a single rotating body comprising a compressor rotor and a turbine rotor interconnected by a rotor shaft, the turbine engine being configured to drive a member by said shaft via an epicyclic reduction gear, said reduction gear comprising at least one first element rotationally secured to said shaft, at least one second element configured to be rotationally secured to said member, and at least one third element configured to be selectively secured to a stator of the turbine engine and disconnected from said stator, said turbine engine comprising means to rotationally drive said third member configured to drive said third element at a piloted speed when it is disconnected from said stator, characterised in that said third element is connected to said stator by braking means, and in that said driving means comprise mechanical connection means to said third element, and mechanical retrieval means of the power from said turbine engine or from a source external to the turbine engine, the driving means being configured so that the power retrieved by the retrieval means is transmitted by the connection means to said third element, for the purpose of rotationally driving said third element; the establishment of a bypass in case of retrieval from the turbine engine can avoid the use of an external power source.

The epicyclic reduction gear is therefore piloted, i.e. the speed of the third element is piloted so as to control the output speed from the reduction gear, i.e. the speed of the second element and the member, within a suitable speed range. Unlike the prior art, where the reduction ratio is not piloted, the reduction ratio thereof can here be adapted to optimise the performance of the turbine engine at different operating points, and/or modify the output speed setpoint.

The turbine engine according to the invention can comprise one or more of the following characteristics, taken individually or in combination:
said third element is an outer ring gear of the reduction gear,
in the event of retrieval from the turbine engine, said mechanical retrieval means are configured to retrieve power from said rotating body or from said member. In the case where the retrieval is from the rotating body, the retrieval occurs upstream from the reduction gear, and in the case where it takes place on the member, it occurs downstream from the reduction gear,
said mechanical retrieval means are connected to one of said elements of said reduction gear,
said retrieval means are reversible, i.e. they are able to operate as a generator or as a motor,
said mechanical connection means are connected to said mechanical retrieval means by an electronic, electric or hydraulic circuit, and
the turbine engine is a turbine engine of a helicopter, said member being a helicopter rotor or an airplane turboprop or turbine engine of an airplane, said member being a propeller or a fan, or an APU, said member being an item of equipment.

The invention also relates to a method for controlling a turbine engine of the type described above, characterised in that it comprises at least:
a step whereby the rotor shaft is disengaged and during which the third element is left free to rotate; and/or
an operating step in linked reduction gear mode, during which the third element is blocked by the braking means.

According to another characteristic of the method, more specifically associated with a turbine engine comprising mechanical retrieval means and means to rotationally drive the third element, consisting of motor-generators interconnected by an electric circuit, this method comprises:
a starting step during which the turbine engine is started by at least one of the motor-generators thereof forming the mechanical retrieval means and the means to rotationally drive the third element, and/or
a turbine engine assistance phase in the transient speeds thereof by at least one of the motor-generators thereof forming the mechanical retrieval means and the means to rotationally drive the third element, and/or
a step whereby APU power is provided, during which the second element is not rotationally driven and/or is blocked, and wherein at least one of the motor-generators thereof forming the mechanical retrieval means and the means to rotationally drive the third element is driven by the turbine engine.

According to another characteristic of this method, more specifically associated with a turbine engine wherein the mechanical retrieval means are the reduction gear and the member, the method further comprises:
a braking step of the member during which at least the motor-generator forming the mechanical retrieval means retrieves the power from said member, and/or
a step whereby a power peak is provided, during which the motor-generator forming the mechanical retrieval means provides power to said member from an external power source, and/or
an electric taxiing step during which the turbine engine is turned off, the motor-generator forming the mechanical retrieval means provides power to said member from an external power source.

### DESCRIPTION OF THE FIGURES

The invention is better understood, and other details, characteristics and advantages of this invention will become clearer upon reading the following description, provided as an example and not limited thereto, and with reference to the appended drawings, wherein:

FIGS. 1 and 2 are schematic and longitudinal cross-sectional views of turbine engines with monoblock body gas generators, respectively in linked turbine mode and in free turbine mode,

FIG. 3 is a longitudinal cross-sectional view of a turbine engine with a reduction gear,

FIG. 4 is a larger scale view of a part of FIG. 3,

FIG. 5 is a perspective and schematic view of a reduction gear of the turbine engine,

FIG. 6 is a view of FIG. 4 illustrating a specific characteristic of the invention,

FIGS. 7 and 8 are highly schematic views of a turbine engine according to the invention, and illustrating an embodiment of the invention, and

FIGS. 9 and 10 are highly schematic views of a turbine engine according to the invention, and illustrating another embodiment of the invention.

### DETAILED DESCRIPTION

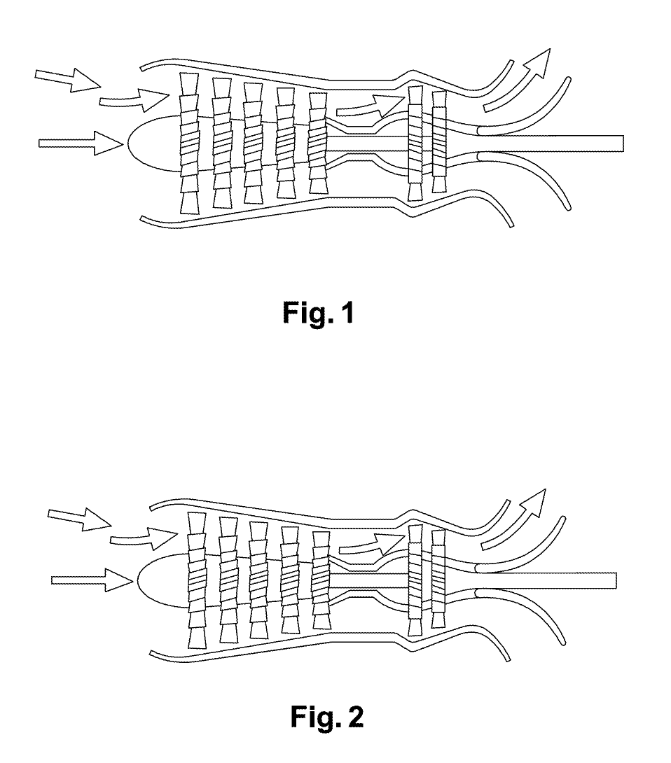

FIGS. 1 and 2 have been briefly commented in the above description. They show a monoblock body aircraft turbine engine comprising a single rotating body. In FIG. 1, the turbine engine comprises a turbine connected to the body of the gas generator and in FIG. 2 the turbine engine comprises a free turbine installed downstream from the turbine and the body of the gas generator.

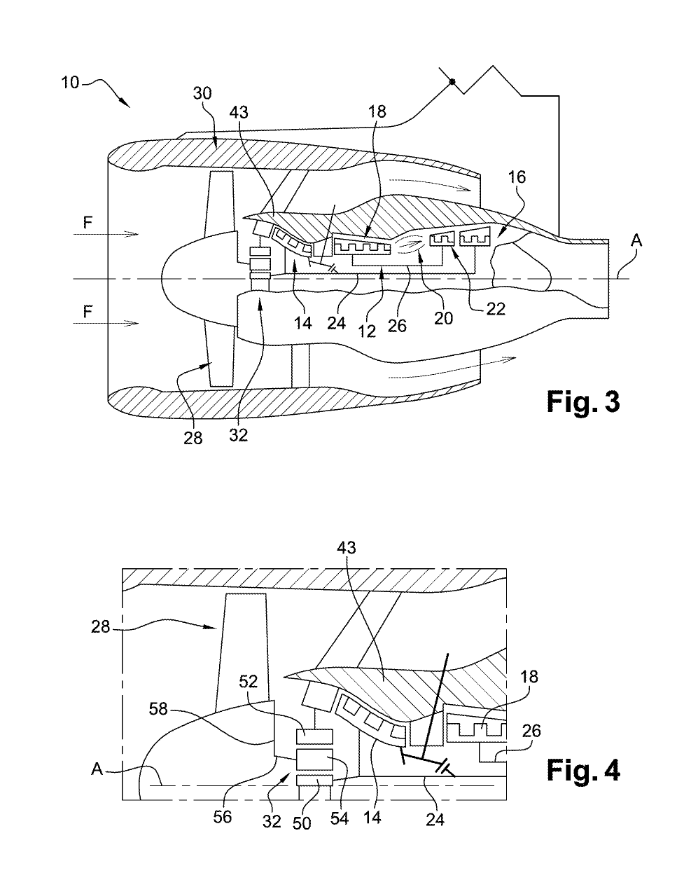

FIGS. 3 and 4 schematically show an aircraft twin-body bypass turbine engine 10.

The turbine engine 10 traditionally comprises a gas generator 12 comprising a low pressure compressor 14, a high pressure compressor 18, a combustion chamber 20, a high pressure turbine 22 and a low pressure turbine 16. In the following description, the terms “upstream” and “downstream” are to be taken in the main direction F of flow of gases within the turbine engine, this direction F being parallel to the longitudinal axis A of the turbine engine. The rotors of the low-pressure compressor 14 and of the low-pressure turbine 16 form a low-pressure or LP body and are interconnected by a low-pressure or LP shaft 24 centred on the axis A. Similarly, the rotors of the high-pressure compressor 18 and the high-pressure turbine 22 form a high-pressure or HP body, and are interconnected by a high-pressure or HP shaft centred on the axis A and arranged about the LP shaft 24.

Moreover, the turbine engine 10 comprises, in front of the gas generator 12, a fan 28. This fan 28 rotates about the axis A and is encased in a fan casing 30. It is indirectly driven by the LP shaft 24 by means of a reduction gear 32 arranged between the LP body and the fan 28, being axially positioned between the latter and the LP compressor 14. The presence of the reduction gear 32 to drive the fan 28 allows for a bigger fan diameter, thereby achieving a higher dilution rate, and therefore allowing for fuel savings.

The reduction gear 32 of FIGS. 3 and 4 comprises an epicyclic reduction gear train. It should be noted that, by convention, the gear train is called epicyclic when the ring gear of the reduction gear is rotationally secured, or configured to be rotationally secured.

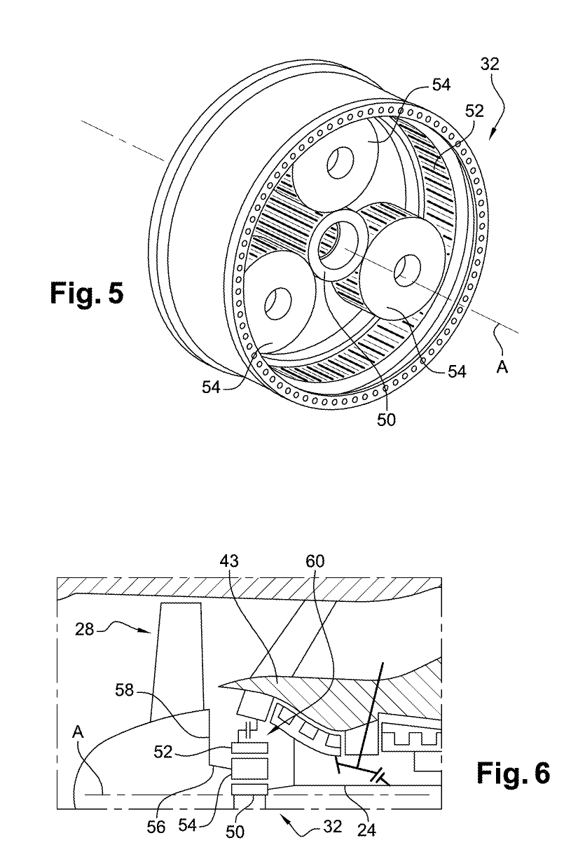

As shown more clearly in FIG. 5, an epicyclic reduction gear 32 comprises a planetary shaft 50 centred on the axis A and rotationally secured to the low-pressure shaft 24, being positioned in the upstream extension of said shaft 24.

The reduction gear 32 further comprises an outer ring gear 52 and planets 54 that engage with the outer ring gear 52 and the planetary shaft 50 and are supported by a planetary carrier shaft 56.

In the epicyclic reduction gear 32, the ring gear 52 is secured to a stator casing of the intermediary flow path 43 and the planetary carrier 56 is rotationally secured to a shaft of the fan 58, the latter generally supporting the blades of the fan by means of a fan disc.

FIG. 6 represents an important feature of the invention, according to which the ring gear 52 of the reduction gear 32 is connected by braking means 60 to the stator casing of the intermediary flow path compartment 43, in this case.

In the braking position, the member 60 secures the ring gear 52 to the stator. The reduction gear 32 then functions like a traditional epicyclic reduction gear with a given reduction ratio. In the piloted position, the member 60 disengages the ring gear 52 from the stator, which can then be piloted by the driving means 82.

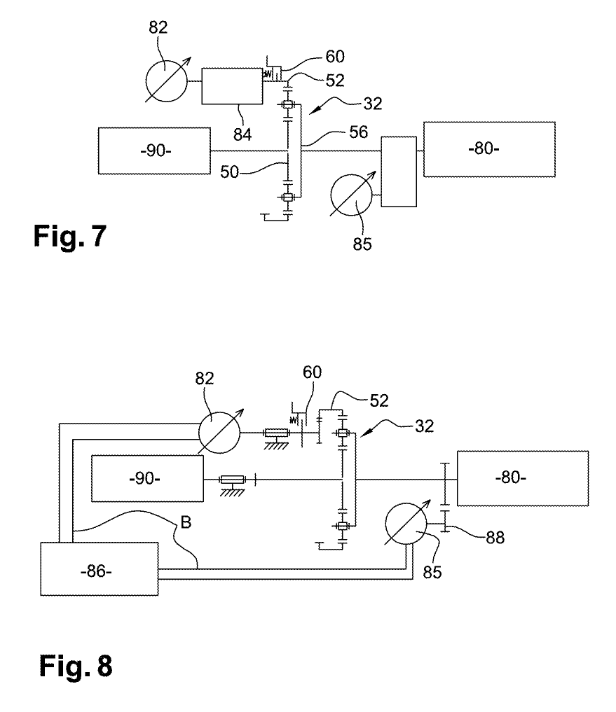

In FIG. 7 and following, which show various embodiments of the invention, the elements described above are identified with the same reference numbers.

FIGS. 7 and 8 show a first embodiment of the invention. In this case, the principle is to pilot the rotation speed of the ring gear 52 of the reduction gear 32 in order to pilot the output speed from the reduction gear 32, i.e. the speed of the member 80 driven by the reduction gear, which is a fan in the above example but could also be a propeller in the case of a turboprop or a rotor in the case of a helicopter turbine engine or an APU.

The turbine engine comprises the means 82 to rotationally drive the ring gear 52 when it is disengaged from the casing by the braking means 60. In the examples provided, the driving means are connected by mechanical connection means 84 to the ring gear, and are connected to means 85 to mechanically retrieve power from the motor. As shown in FIG. 8, the connection between the mechanical connection means and the retrieval means is achieved with an electric, hydraulic or electronic circuit 86. In other words, part of the turbine engine's power is retrieved and routed through the circuit 86 to rotationally drive the ring gear.

The method chosen to drive the ring gear requires a smaller torque, and consequently, with respect to another solution, allows the implementation of driving means 82 featuring reduced size and weight.

In the case of FIGS. 7 and 8, the retrieval means are located downstream (in reference to the direction of mechanical transmission) from the reduction gear 32, between the reduction gear and the member 80 driven by the reduction gear. The retrieval means 85 can be mechanically connected by a pinion 88 or a similar element to the output shaft of the reduction gear, as seen in the represented example.

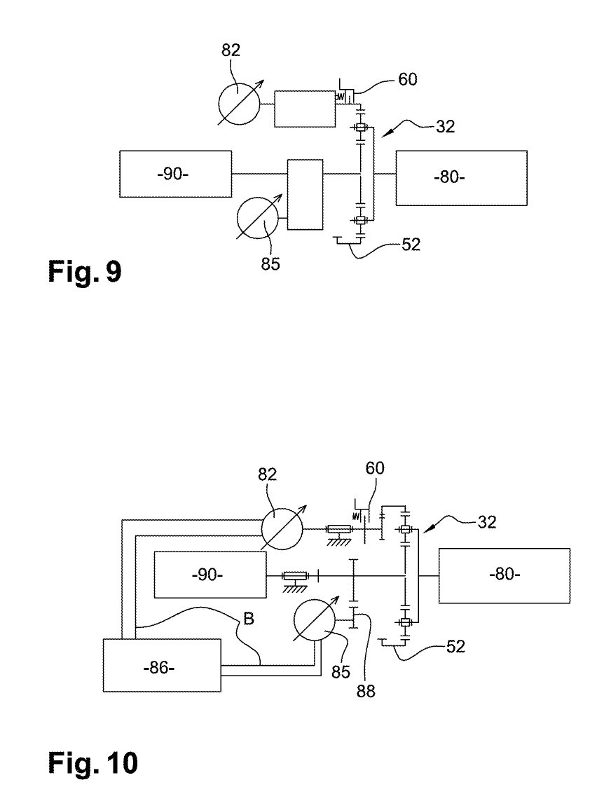

In the case of FIGS. 9 and 10, the retrieval means 85 are located upstream from the reduction gear 32, between the reduction gear and the gas generator 90. The retrieval means 85 can be mechanically connected by a pinion 88 or a similar element to the input shaft of the reduction gear, as seen in the represented example.

The driving means 82 can comprise at least one motor and the retrieval means 85 can comprise at least one generator. It should be noted that the couplings of motors and generators may vary depending on the application. In this context, coaxial motors/generators with shafts feature some interest (synchronous or rotationally driven by a dedicated transmission system). More conventional geared driving means are also possible.

The abovementioned means 82, 85 can be hydraulic or electric, and reversible (driven or motors).

The solutions described above define operations of the turbine engine according to several individual steps.

Therefore, the solutions described above have the advantage of overcoming two disadvantages of the abovementioned toroidal CVT system, which are:
they enable to disengage the rotor shaft 24, leaving the ring gear free to rotate. Thus, the use of an additional clutch is no longer needed (gains in cost and weight), especially for turbine engine applications,
they allow for the transmission of high torques through a primarily mechanical power transmission; the use of an additional reduction gear is no longer required (again, gain in cost and weight).

However, an additional power source is required to servo-control the ring gear, which in this example is materialized by the members of the diversion branch B.

For obvious safety reasons, this system could have a safety system in case of failure of the members of the diversion branch B. A failure of the regulation system could result in the release of the ring gear, which would disengage the motor and cause it to go into overspeed. The braking means 60, closed by default, could ideally fulfil this function.

A safeguard rule could be defined to allow the implementation of braking means 60. The turbine engine will then behave like a turbine engine with a linked turbine, the blocking of the ring gear resulting in the conversion of the reduction gear 32 into a piloted ring gear in conventional epicyclic train.

It should be noted that the electric circuit system 86 allows for several possibilities. The starting of the turbine engine can be performed in the case of electric diversion systems by using existing electric motors. Thus, it is no longer useful to maintain a dedicated conventional generator/starter (gain of weight).

Furthermore, it should be noted that the second embodiment shown in FIGS. 9 and 10 facilitates the starting of the turbine engine with respect to the first embodiment shown in FIGS. 7 and 8.

In the first embodiment, preferably, starting is governed by a rule that is yet to be defined, using for example the retrieval means 85 and the driving means 82 consisting of motor-generators that are configured to work as motors or generators, alternately.

Similarly and for both embodiments, the two motor-generators of the diversion circuit could be used to
assist the primary motor during transients,
enable fast starts by using the available electric power, and
enable fast starts by using the inertia of the main rotor, as necessary.

Once started, the engine can drive one of the generators of the reduction gear 32 to provide the power needed by the aircraft (APU mode) while ensuring that the rotor of the helicopter or the propeller of the airplane is not rotationally driven. For example, this could be achieved:
in the first embodiment by blocking the output of the reduction gear 32 (e.g. with the generator—retrieval means 85—and the braking means), by retrieving power from the ring gear with the generator 82.
in the second embodiment, by retrieving power from the generator 85 and leaving the ring gear free to rotate.

Therefore, in the first embodiment, the generator 85 of the ring gear 32 can advantageously replace the BTP generator. Indeed, the generator 85 is driven at a constant speed in a turbine engine application.

Similarly, in the case of the first embodiment, the generator 85 of the ring gear 32 can be used to brake the rotor after landing, when the aircraft is on the ground. Depending on the selected generator 85 technology, the generator can replace the helicopter brakes or simply assist them. In any case, the generator can be used to retrieve the energy of the rotor, to recharge the batteries for example.

Similarly, in the case of the first embodiment, the generator 85 of the reduction gear 32 could make it easier to provide a power surge (although limited at approximately one hundred kW) to assist the pilot with autorotation by electric retrieval from an external source (e.g.: APU, batteries).

Similarly, in the case of the first embodiment, the generator 85 of the reduction gear 32 could make it easier to provide power to the propeller or the fan of an airplane for electric taxiing. Therefore, it is possible to consider a propeller rotationally driven by an electric system when the motor is off. The power, in this case, will have to come from an external power source:
batteries,
APU, or
another running motor for multi-engines aircraft.

The present invention would allow:
in the case of a reduction gear 32 associated with a linked turbine:
   to eliminate the transversal supercritical shaft, reduce the diameter of the discs, remove the shielding,
   to use the gas generator at speeds and powers freely selected, enabling varied piloting strategies and performance gains, while allowing a wide output speed setpoint,
   to not have to use a clutch to start the motor,
in the case of a reduction gear 32 associated with a free turbine:
   to use the free turbine in optimised operating ranges while enabling a wide output speed setpoint,
to provide reduction gear and continuously variable functions simultaneously through the epicyclic gear train,
remain compatible with identified hybridisation solutions, without causing major weight increases, as the motor-generators are already present for the reduction gear 32:
   restarting, fast restarting and transient assistance,
   communalisation of the generator and the BTP (first embodiment),
   enabling an APU mode with the engine on and the rotor or propeller stopped,
   (low) assistance for autorotation for the turbine engine and assistance with the electric taxiing for the turboprop, and
   primary rotor braking with the electric motor on the output shaft (first embodiment).

The invention is particularly advantageous when applied to a monoblock body aircraft turbine engine, as it offers great responsiveness to transient speeds, the compression rate of the compressor being immediately available. Furthermore, this type of turbine engine offers a simplified architecture.

1. A turbine engine, comprising at least one rotating body comprising a compressor rotor and a turbine rotor interconnected by a rotor shaft, the turbine engine being configured to drive a member by said rotor shaft via an epicyclic reduction gear, said epicyclic reduction gear comprising at least one first element rotationally secured to said rotor shaft, at least one second element configured to be rotationally secured to said member, and at least one third element configured to be selectively secured to a stator of the turbine engine and disconnected from said stator, said turbine engine comprising a driving means configured to rotationally drive said third element at a piloted speed when it is disconnected from said stator, wherein said third element is connected to said stator a brake, and said driving means comprise a mechanical connection to said third element and a mechanical retrieval means for retrieving power from said turbine engine or from an external source, the driving means being configured so that the power retrieved by the mechanical retrieval means is transmitted by the mechanical connection to said third element to rotationally drive said third element.

2. The turbine engine according to claim 1, wherein said third element is an outer ring gear of the epicyclic reduction gear.

3. The turbine engine according to claim 1, wherein said driving means are reversible.

4. The turbine engine according to claim 1, wherein said mechanical retrieval means are configured to retrieve power from at least one of said rotating body and said member.

5. The turbine engine according to claim 1, wherein said mechanical retrieval means are connected to said epicyclic reduction gear.

6. The turbine engine according to claim 3, wherein said mechanical connection are connected to said mechanical retrieval means by an electronic, electric or hydraulic circuit.

7. (canceled)

8. The turbine engine according to claim 1, wherein the turbine engine is one of: a turbine engine of a helicopter, said member being a helicopter rotor; a turboprop or turbine engine of an airplane, said member being a propeller or a fan; or an APU.

9. A method for controlling a turbine engine according to claim 1, comprising:
disengaging the rotor shaft and allowing the third element to rotate freely; and
operating the turbine engine while the third element is blocked by the brake.

10. A method for controlling the turbine engine according to claim 6, comprising:
starting the turbine engine with a motor-generator that forms the mechanical retrieval means and the driving means to rotationally drive the third element;
assisting the turbine engine with the motor-generator while the turbine engine rotates at a transient speed; and
providing APU power while the second element does not rotate, where the motor-generator is driven by the turbine engine.

11. The method of claim 10, further comprising:
braking the member while the motor-generator retrieves power from the member;
providing a power peak while the mechanical retrieval means provides power to said member from an external power source; and
turning off the turbine engine while the motor-generator provides power to said member from the external power source.
